(19) United States
(12) Patent Application Publication
(10) Pub. No.: US 2010/0165849 A1
(43) Pub. Date: Jul. 1, 2010

(54) Failure Detection in IP Networks Using Long Packets

(76) Inventors: Martin Eisenberg, Holmdel, NJ (US); Moshe Segal, Tinton Falls, NJ (US); Sivaram Chelluri, West Windsor, NJ (US)

Correspondence Address: AT&T Legal Department - HBH;Attn: Patent Docketing, One AT&T Way, Room 2A-207, Bedminster, NJ, 07921, US

(21) Appl. No.: 12/344,894

(22) Filed: Dec. 29, 2008

(51) Int. Cl. G06F 11/30

(52) U.S. Cl. 370/242

(57) ABSTRACT

This description provides tools and techniques for detecting failures in IP networks using long packets. These tools may provide apparatus for monitoring several different communication paths between route processor modules within a given communications network. The apparatus selects one of the communication paths for connectivity testing, and sends both short and long test packets over the selected communications path. The apparatus then evaluates whether the test packets are transmitted successfully along the communication path.

### BACKGROUND

Modern telecommunications networks typically include a number of different elements, as communication paths or links established between at least some of these different elements. These communication paths are adapted to transmit network traffic, with examples of this network traffic including packets defined according to appropriate protocols. Over time, some of these communication paths may become inoperative. Previous network monitoring tools may test connectivity between these network elements by periodically broadcasting broadcast test packets of one length along these communications paths.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This description provides tools and techniques for detecting long-packet failures in IP networks using long test packets in addition to the detection of ordinary failures using short packets. The ability to detect long-packet problems is achieved without the necessity of increasing the number of test packets transmitted or using additional hardware. These tools may provide apparatus for monitoring several different communication paths between route processor modules within a given communications network. The apparatus selects one of the communication paths for connectivity testing, and sends both short and long test packets over the selected communications path. The apparatus then evaluates whether the test packets are transmitted successfully along the communication path.

Other apparatus, systems, methods, and/or computer program products according to embodiments will be or become apparent to one with skill in the art upon reviewing the following drawings and Detailed Description. It is intended that all such additional apparatus, systems, methods, and/or computer program products be included within this description, be within the scope of the claimed subject matter, and be protected by the accompanying claims.

### BRIEF DESCRIPTION OF THE DRAWINGS

FIG. 1 is a combined block and flow diagram illustrating systems or operating environments for failure detection in IP networks using long packets.

FIG. 2 is a combined block and flow diagram illustrating respective state machines associated with various communication paths or links shown in FIG. 1.

FIG. 3 is a state diagram illustrating how the state machines shown in FIG. 2 may transition between different states in response to successful or failed transmissions of long and short test packets.

FIG. 4 is a flow diagram illustrating example single-link processes related to failure detection in IP networks using long packets.

FIG. 5 is a flow diagram illustrating example of multi-link processes related to failure detection in IP networks using long packets.

### DETAILED DESCRIPTION

The following detailed description is directed to methods, systems, and computer-readable media (collectively, tools and/or techniques) for failure detection in IP networks using long packets. While the subject matter described herein is presented in the general context of program modules that execute in conjunction with the execution of an operating system and application programs on a computer system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

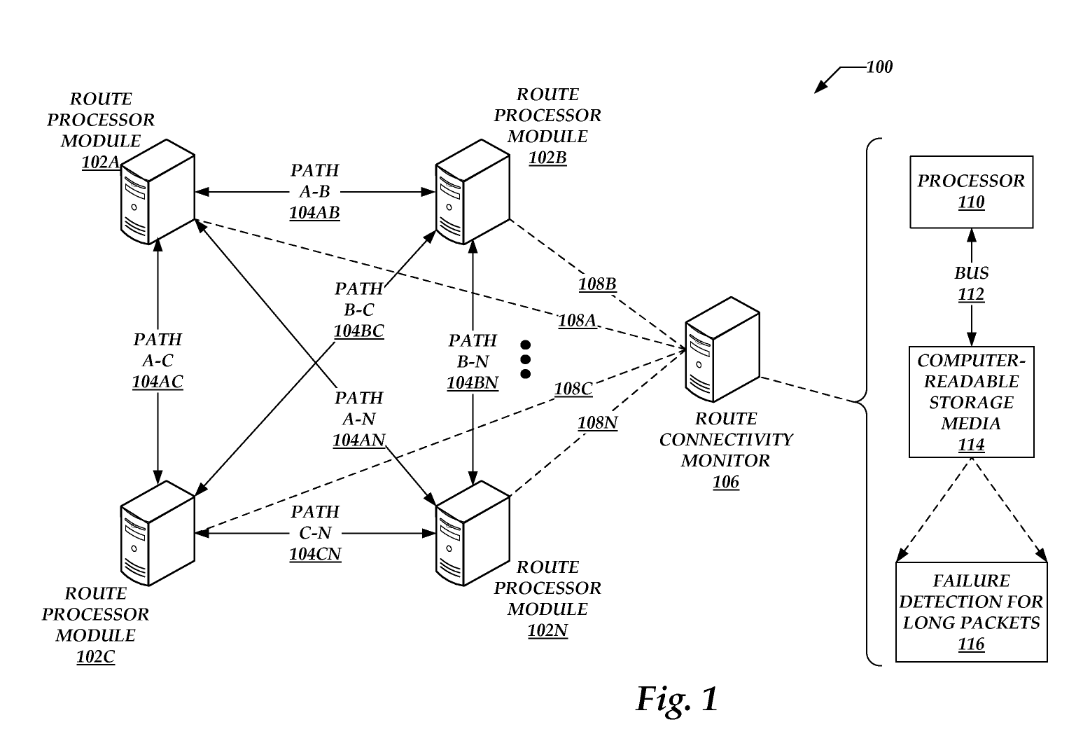

FIG. 1 illustrates systems or operating environments, denoted generally at 100, for failure detection in IP networks using long packets. These systems 100 may include any number of route processor modules (RPMs), with FIG. 1 illustrating an example scenario including for RPMs 102a, 102b, 102c, and 102n (collectively, RPMs 102). In general, the RPMs 102 may function to route packet traffic around and through one or more given communications networks (not shown explicitly in FIG. 1 in the interest of clarity). For example, without limiting possible implementations of this description, the RPMs 102 may represent routers or other suitable switching devices.

FIG. 1 illustrates for RPMs 102 only to facilitate this description, but not to limit possible implementations of this description. More specifically, such implementations may incorporate any number of RPMs 102 without departing from the scope and spirit of this description.

Respective paths or links may place pairs of the RPMs 102 in communication with one another. In the example shown in FIG. 1, a path or link 104ab connects the RPM 102a with the RPM 102b, a path or link 104bn connects the RPM 102b with the RPM 102n, a path or link 104cn connects the RPM 102c to the RPM 102n, and a path or link 104ac connects the RPM 102a to the RPM 102c. Similarly, a path or link 104an connects the RPM 102a to the RPM 102n, and a path or link 104bc connects the RPM 102b to the RPM 102c. According to exemplary embodiments, although not necessarily, these paths or links (denoted collectively as paths or links 104) are bidirectional in nature, thereby facilitating communication in either direction between respective pairs of the RPMs 102.

Over time, one or more of these links may fail, and in some cases, it may return to operational status after such failures. The operating environments 100 may include one or more route connectivity monitors (RCMs) 106. The RCMs 106 may communicate with the various RPMs 102, as represented generally by dashed lines 108a-108n shown in FIG. 1. More specifically, the RCM 106 may send test packets along the lines 108, thereby causing the different RPMs 102 to transmit the test packets along the various paths or links 104. For example, to test the communication path 104ab, the RCM 106 may send test packets along the line 108a to the RPM 102a. In turn, the RPM 102a may send the test packet along the communication path 104ab to the RPM 102b. Finally, the RPM 102b may send the test packet to the RCM 106 along the line 108b. In this scenario, the RCM 106 may track when it originally sent the test packet along the line 108a, and may also track when (or if) it received the test packet along the line 108b. In cases where test packets do not arrive back at the RCM 106, the RCM 106 may detect that these test packets have been dropped or lost. Such dropped or lost test packets occurring along different communication paths 104 may indicate connectivity problems affecting these paths, or may indicate configuration issues affecting one or more of the RPMs 102.

In this manner, the RCM 106 may test the connectivity between various one of the RPMs 102 on an ongoing basis. As the RCM 106 finds different paths or links 104 to be either up or down, the RCM 106 may generate suitable alerts accordingly. These alerts may be routed to human administrators as appropriate for resolution and follow-up action.

Turning to the RCMs 106 in more detail, the RCMs may include one or more processors 110, which may have a particular type or architecture, chosen as appropriate for particular implementations. The processors 110 may couple to one or more bus systems 112 chosen for compatibility with the processors 110.

The RCMs 106 may also include one or more instances of computer-readable storage medium or media 114, which couple to the bus systems 112. The bus systems 114 may enable the processors 110 to read code and/or data to/from the computer-readable storage media 114. The media 114 may represent apparatus in the form of storage elements that are implemented using any suitable technology, including but not limited to semiconductors, magnetic materials, optics, or the like. The media 114 may include memory components, whether classified as RAM, ROM, flash, or other types, and may also represent hard disk drives.

The storage media 114 may include one or more modules of instructions that, when loaded into the processor 110 and executed, cause the RCMs 106 to perform various techniques related to failure detection in IP networks using both long and short packets. FIG. 1 provides examples of such software modules at 116. As detailed throughout this description, these modules of instructions 116 may also provide various means, tools, or techniques by which the RCMs 106 may provide for failure detection in IP networks using long and short packets, using the components, flows, and data structures discussed in more detail throughout this description.

For convenience of discussion only this description provides examples in which the tools and techniques described herein are implemented in software. However, it is noted that these tools and techniques may also be implemented in hardware and/or circuitry without departing from the scope and spirit of this description.

The RCMs 106 may be adapted to transmit both long and short test packets. The actual byte lengths of these packets may vary in different implementations. However, for the purposes of this description, the term “short” packet may refer to a packet that is approximately 52 bytes long. The term “long” packet may refer to a packet having a length of, for example, 1500 bytes, 4400 bytes, or other suitable length relatively longer than the “short” packets.

The short packets may expose certain types of path failures when transmitted as test packets between the RPMs 102. However, other types of path failures may become manifest only when the RCM 106 causes the RPMs 102 to transmit the long test packets. For example, once packets exceed a certain length, these packets may be handled differently than shorter packets. More specifically, these longer packets may be broken into smaller pieces for transmission, and reassembled after transmission. In some cases, configuration issues affecting the RPMs 102 may negatively affect handling that is specific for the longer packets. Accordingly, by broadcasting long test packets as well as short test packets, the RCM 106 may expose these types of configuration or connectivity issues.

In light of the foregoing observations, the RCM 106 may modify the transmission of packets, so that a configurable ratio or percentage (e.g., one-tenth, or any other suitable ratio) of the RPM-to-RPM probes are long packets. It is noted that the RCM 106 does not broadcast more packets. Instead, the overall number of packets remains the same, as compared to previous approaches. However, some subset or percentage of these overall packets may be long packets rather than short packets. Whereas previous techniques may transmit only short packets, the techniques described herein may substitute or replace some of these short packets with long packets. In an example scenario, the RCM 106 may divide a given segment of time into ten-cycle intervals. During the first of the ten cycles, one-tenth of the probe packets may be long packets. During the second of the ten cycles, a different one-tenth of the probe of packets would be long, and so on. The whole sequence of ten cycles would then be repeated on an ongoing basis, with the RCM 106 continually testing how many of the packets are successfully transmitted over different ones of the paths or links 106 over time.

The RCM 106 may adjust the ratio of long packets to short packets in these probes in light of different considerations. For example, because the long packets are appreciably longer than the short packets, transmitting these long packets between the RPMs 102 consumes greater bandwidth, as compared to transmitting the short packets. If the ratio of long packets to short packets is too high, too much of the bandwidth and resources of the RPMs 102 may be devoted to transmitting test packets, rather than “live” traffic, thereby delaying such “live” traffic. However, if the ratio of long packets to short packets is too low, it may take too long to detect network connectivity issues that are exposed only by long test packets. A given implementation of the RCM 106, or more broadly the operating environments 100, may resolve these trade-offs as suitable for the circumstances of this implementation.

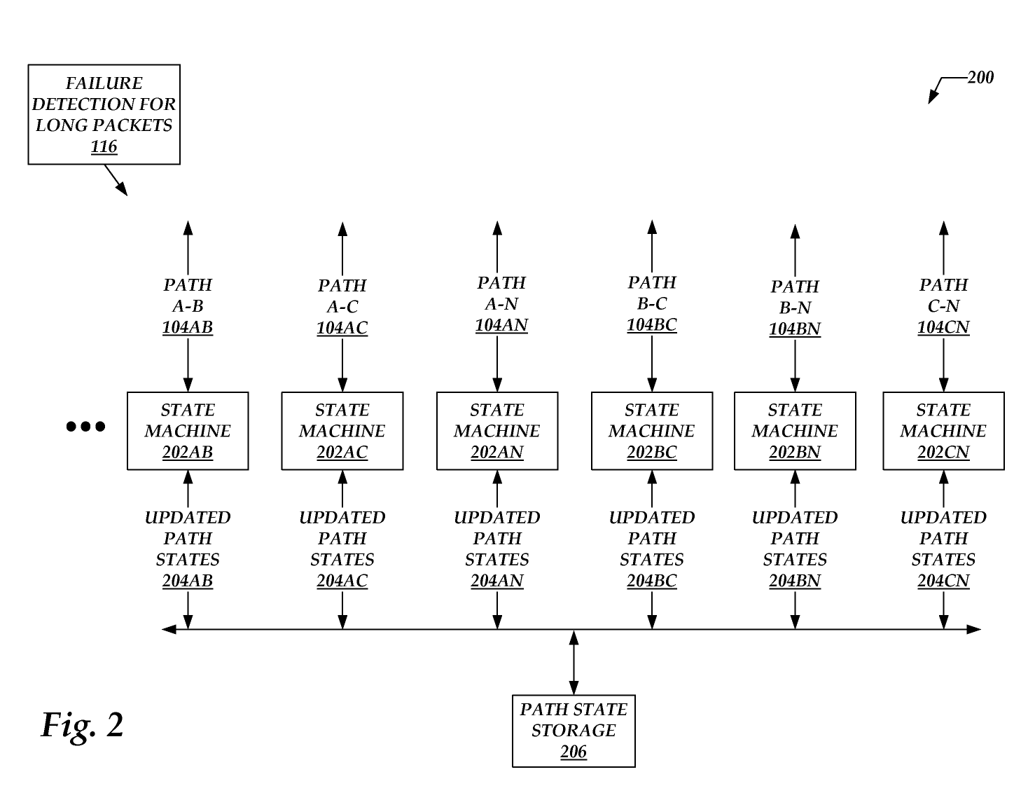

Having described the operating environments 100 for failure detection in IP networks using long packets, the discussion now turns to a description of various state machines associated with different ones of the paths or links 104. This description is now provided with FIG. 2.

FIG. 2 illustrates respective state machines, denoted generally at 200, that are associated with various communication paths or links as shown in FIG. 1. For convenience of description and reference, but not to limit possible implementations, FIG. 2 may carry forward certain features from previous Figures, and may denote them using the same reference numbers. For example, the tools 116 may implement the state machines 200 in connection with failure detection for long packets.

As shown in FIG. 2, respective state machines 202ab, 202ac, 202an, 202bc, 202bn, and 202cn (collectively, the state machines 202) may be associated with the paths or links 104 discussed above in FIG. 1. Accordingly, the number of state machines 202 may vary according to the number of paths or links the monitored by the RCM 106, or more specifically the tools 116.

Over time, as the RCM 106 causes the RPMs 102 to transmit test packets along different ones of the paths or links 104, the state machines 202 may change state depending on whether the test packets were transmitted successfully along the paths or links 104. As shown in FIG. 2, different state machines 202 may output respective state information 204ab, 204ac, 204an, 204bc, 204bn, and 204cn (collectively, state information 204). As detailed further below, this state information 204 may indicate whether a given path or link 104 is deemed operative (i.e., in an “up” state) or inoperative (i.e., in a “down” state). In addition, this state information 204 may indicate whether the last packet sent over a given link 104 was successfully transmitted. In cases where the last packet transmission over the given link 104 was a failure, the state information may also indicate how many consecutive packet failures have occurred on that given link 104.

The tools 116 may also maintain path state storage elements, denoted generally at 206. This path state storage 206 may contain representations of different paths 104 and related instances of state information 204. In this manner, the tools 116 may track which paths are in an “up” state, which are in any “down” state, and how many consecutive packet losses have occurred on different paths 104. As described in further detail below, some algorithms may operate only with state information associated with a given path. However, other algorithms (e.g., the algorithms described herein for detecting long-packet failures) may operate with state information associated with two or more different paths. The path state storage 206 may facilitate operation of the latter algorithms, enabling state information to be visible across different state machines.

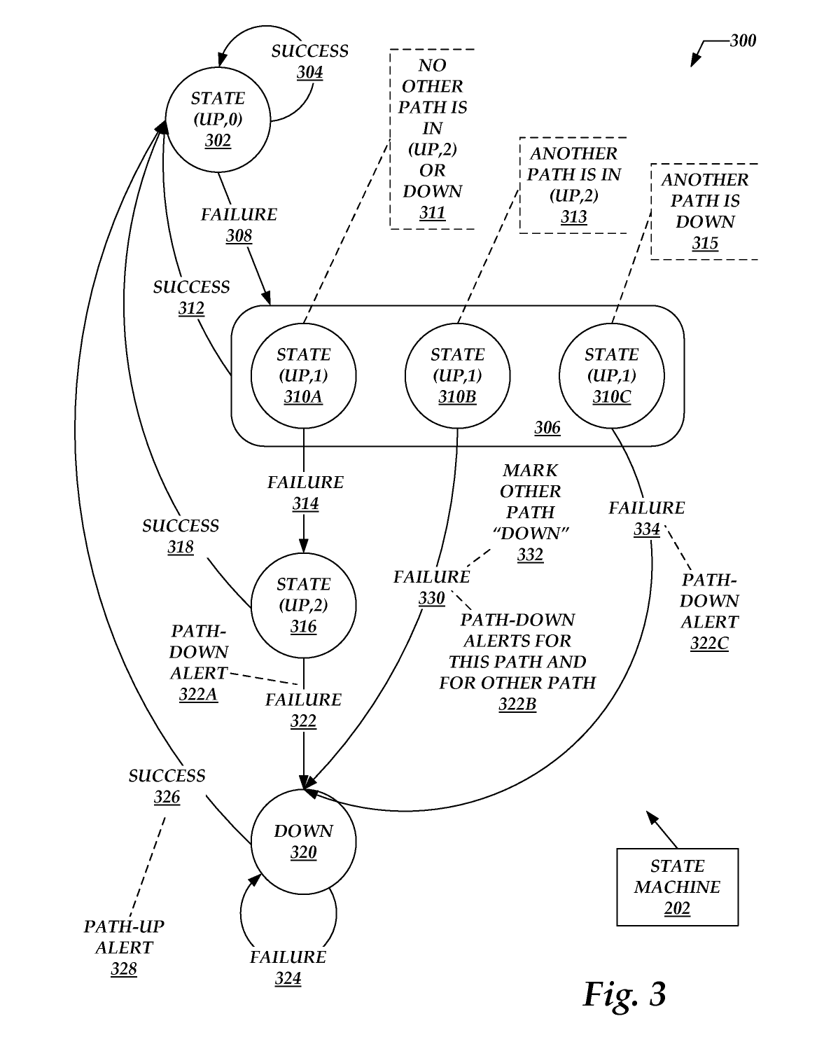

FIG. 3 illustrates state diagrams, denoted generally at 300, illustrating how the state machines shown in FIG. 2 may transition between different states in response to successful or failed transmissions of long and short test packets. For convenience of description and reference, but not to limit possible implementations, FIG. 3 may carry forward certain features from previous Figures, and may denote them using the same reference numbers. For example, the state diagrams 300 may be understood as elaborating further on a representative state machine 202 from FIG. 2.

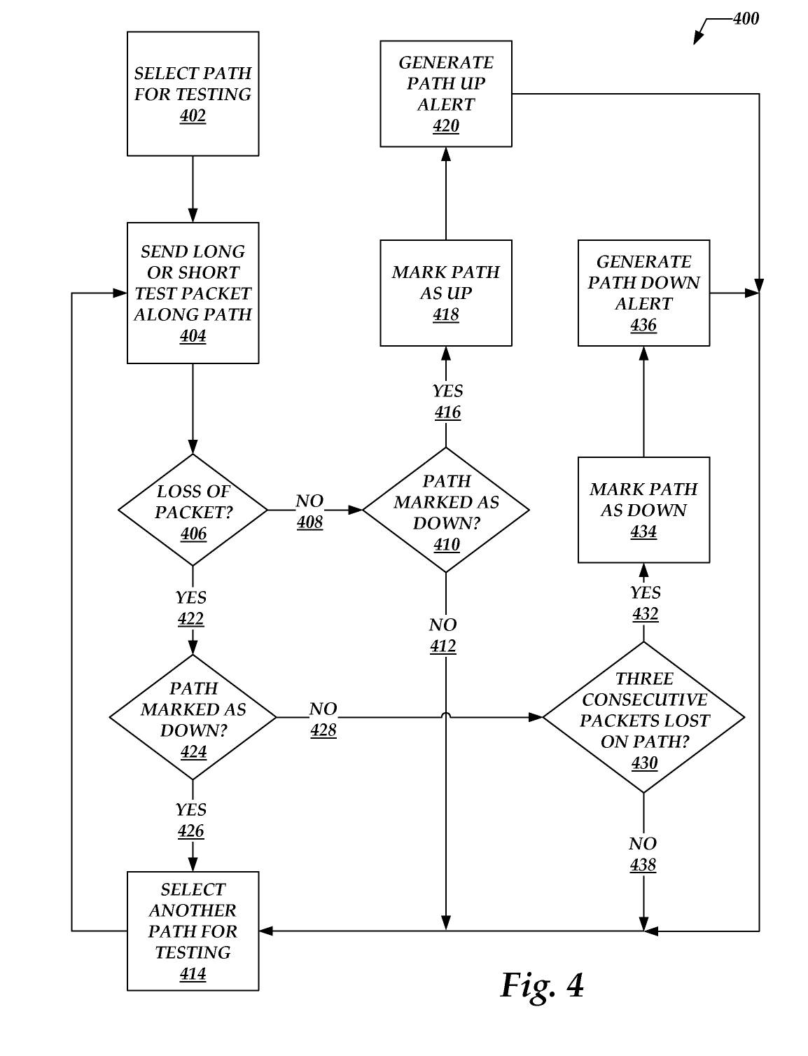

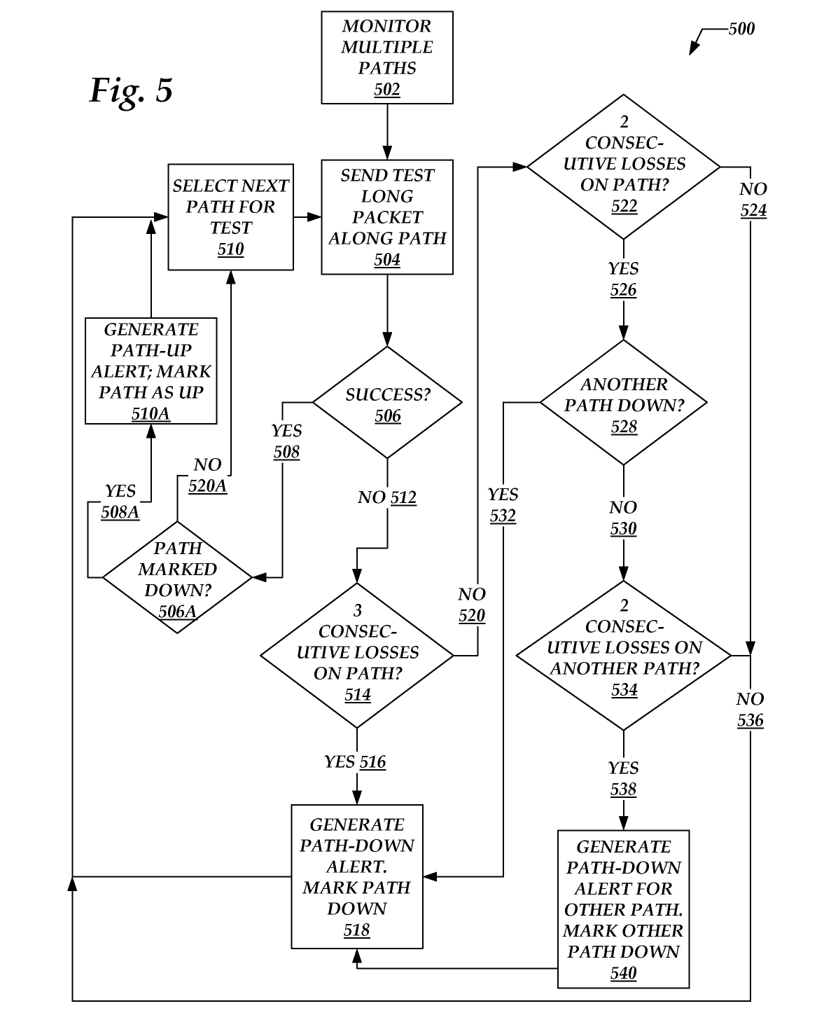

The state diagrams 300 shown in FIG. 3, as well as related algorithms shown in FIGS. 4 and 5, may reduce the detection time for connectivity problems exposed by long packets. The concern about detection time is mainly for the long-packet case, since long packets are sent less frequently, and hence the failure detection time is longer as compared to the short packets. Thus, these state diagrams and algorithms may be particularly suitable for exposing long-packet failures, although implementations of this description could also use these state diagrams and algorithms to improve detection times for short-packet failures without departing from the scope and spirit of the present description.

Rather than using packet loss information only for a given path to generate alerts for that path, the state machines and algorithms vied herein may use information about packet losses for all paths. Although the drawings Figures and this description provides examples of fixed thresholds (e.g., 3 consecutive losses or 2 consecutive losses while another path had 2 consecutive losses), implementations of this description may set these thresholds to any convenient integers. Summarizing the description provided below, a path-down alert may be generated if either:
1) 3 consecutive losses occurred for a path, or
2) 2 consecutive losses occurred for a path, and another path also had 2 consecutive losses or another path was down.

A state diagram for a given path P follows:

| Old State | Event | New State | Action |
|---|---|---|---|
| (UP, L), L = 0, 1, or 2 | Success | (UP, 0) | |
| (UP, 0) | Failure | (UP, 1) | |
| (UP, 1), and no other | Failure | (UP, 2) | |
| path is in either in state | | | |
| (UP, 2) or DOWN | | | |
| (UP, 1), and another | Failure | DOWN for P | Generate path-down |
| path Q is in state (UP, 2) | | DOWN for Q | alerts for both P |
| | | | and Q |
| (UP, 1), and another | Failure | DOWN | Generate path-down |
| path is DOWN | | | alert |
| (UP, 2) | Failure | DOWN | Generate path-down |
| | | | alert |
| DOWN | Success | (UP, 0), | Generate path-up |
| | | | alert |
| DOWN | Failure | DOWN | |

Implementations of this state diagram may reduce the detection time for failures, particularly long-packet failures. The improvement in detection time they depend on the number of paths that experience service interruption when there is a network failure. As shown below, the average detection time (D) may be calculated as a function of the number of paths affected by the network failure (M). omitting the derivation in the interests of brevity, the result is:

$$D = \frac{5}{2} T , for M = 1 , \\ D = \frac{3}{2} T + \frac{1}{{M}^{2}} T , for M > 1 ,$$

where T is the cycle time ((e.g., 20 minutes, if the cycle time for short packets is 2 minutes and the fraction of long packets is 1/10). Typically, a network failure affects many paths, so M would normally be large. In that case, the average detection time would be 3/2 T.

Note that at any one time, at most one path can be in the state (UP, 2); if one path was in this state and another path was to experience its second lost packet, then the state of both paths would become DOWN. In addition, in the examples described above, no path would be in the state (UP, 2) if any other path is DOWN; if any paths were DOWN and another path experienced its second lost packet, then its state would also become DOWN.

To avoid having to search through all paths to find out if any are in state (UP, 2) or DOWN, implementations of this description may keep track of whether the system has any path in state (UP, 2), and if so, which path, and also keeping track of the number of paths that are DOWN. For example, the path state storage elements shown in FIG. 2 at 206 may facilitate this function. Thus, the additional state information may include (Path, Down), where Path would either be NULL or the identity of the path in state (UP, 2), and Down would represent the number of paths DOWN. If Down were positive, then Path would be NULL, and if Path were non-NULL, then Down would be zero.

In such implementations, the above state diagram for path P may be modified by including the new state variables as shown in italics below:

| Old State | Event | New State | Action |
|---|---|---|---|
| (UP, L), L = 0 | Success | (UP, 0) | |
| or 1 | | | |
| (UP, 0) | Failure | (UP, 1) | |
| (UP, 1), | Failure | (UP, 2), | |
| (NULL, 0) | | (P, 0) | |
| (UP, 1), | Failure | DOWN for P, | Generate path-down |
| (Q, 0) | | DOWN for Q | alerts for both P and Q |
| | | (NULL, 2) | |
| (UP, 1), | Failure | DOWN, | Generate path-down |
| (NULL, Down), | | (NULL, Down + 1) | alert |
| Down > 0 | | | |
| (UP, 2), | Success | (UP, 0) | |
| (P, 0) | | (NULL, 0) | |
| (UP, 2), | Failure | DOWN, | Generate path-down |
| (P, 0) | | (NULL, 1) | alert |
| DOWN, | Success | (UP, 0), | Generate path-up alert |
| (NULL, Down) | | (NULL, Down − 1) | |
| DOWN | Failure | DOWN | |

This state diagram is based on the events “Success” or “Failure”, which respectively denote that a long packet was received successfully or was not received successfully. Implementations of the above state diagram may reduce the detection time for long packets, without a significant impact on the amount of processing involved.

Turning to FIG. 3 in more detail, a given state machine 202 may begin in an initial state 302, which indicates that the path or link (e.g., 104) represented by the state machine 202 is in an “up” state, and has not yet suffered any packet losses. The notation (UP, 0) as shown at 302 represents this initial condition of the state machine 202. So long as long test packets are successfully transmitted over the given path 104, the state machine 202 remains in state 302, as represented by the success loop 304.

From state 302, once a packet failure occurs over a given link 104, the state machine 202 may transition to state 306 via failure branch 308. More specifically, when entering the state 306, the state machine 202 may transition to one of the different sub-states 310a, 310b, and 310c (collectively, internal sub-states 310), depending on the state of one or more other links 104. The notation (UP, 1) appearing in the internal sub-states 310 indicates that the given link 104 is in an “up” state, but has suffered one consecutive packet loss.

Once the state machine 202 for the link 104 has arrived at the state 306, if the next test packet sent along a link 104 is received successfully, the state machine 202 returns to state 302 via success branch 312. However, if the link 104 does not successfully receive this next test packet, that link 104 will have suffered two consecutive packet failures. In this scenario, the next transition for the state machine 202 may depend on which internal sub-state 310 the state machine is in when the second consecutive packet failure occurs.

Turning to the internal sub-states 310 in more detail, the state machine 202 for the given link 104 may occupy the first sub-state 310a when no other link is in a condition represented by the notation (UP, 2) or is in an inoperative or “down” state. As described in more detail below, the state machine 202 may select one of the sub-states 310a, 310b, or 310c when entering the state 306 from the state 302. From state 306 (more specifically, from any of the sub-states 310a, 310b, or 310c), the state machine 202 transitions out of state 306, either returning to the state 302 for a successful packet transmission or advancing to one of the states described below for a failed packet transmission.

From the internal sub-state 310a, once another test packet failure occurs, the state machine 202 may take failure branch 314 to state 316. As indicated in FIG. 3, the state 316 as represented by the notation (UP, 2), which conveys that the link represented by the state machine 202 is currently operational, but has suffered two consecutive packet failures.

From the state 316, if the next test packet is a success, the state machine 202 may take success branch 318 to return to the state 302. However, from the state 316, if the next test packet is a failure, the state machine 202 may transition to an inoperative or “down” state 320, by taking failure branch 322. The transition of state machine 202 for the given link 104 from state 316 to the down state 320 may cause the state machine 202 to generate a “path-down” alert, as represented generally at 322a. In addition, the path-down alert 322a may be associated with the failure paths 330 and 334, which are described below. More specifically, the two path-down alerts associated with the failure path 330 are denoted at 322b, and the path-down alert associated with the failure path 334 is denoted at 322c. In turn, the tools 116 may store an indication in the path state storage 206 that the given link 104 is down or inoperative. In this manner, state machines 202 for other links 104 may be notified that the given link 104 is inoperative.

So long as successive test packets sent on the given link 104 continue to fail, the state machine 202 may remain in the down state 320, as represented by the failure loop 324. However, from the down state 320, if the next test packet sent on the given link 104 is a success, the state machine 202 may return to state 302 via success branch 326. Put differently, this successful transmission of a test packet along the link 104 may return the state machine 202 to an “up” state and would generate path-up alert 328.

Returning to the state 306, the state machine may transition to the internal sub-state 310b in response to determining that at least one other path is deemed operative, but has suffered two consecutive packet losses. This condition of the other path is conveyed by the notation (UP, 2) shown at 313.

From the internal sub-state 310b, if the next test packet is a failure, the state machine 202 may transition to the inoperative or “down” state 320 by taking failure branch 330. This transition of the state machine 202 may cause the state machine that represents the other path to transition to a “down” state, as indicated at 332. This transition would also cause the generation of path-down alerts for both the current path and the other path.

Returning once again to the state 306, the state machine may transition to the internal sub-state 310c in response to determining that at least one other path is deemed inoperative or in the “down” state, as represented at 315. From the internal sub-state 310c, if the next test packet is a failure, the state machine 202 may transition to the down state 320 via failure branch 334. In comparing failure branch 330 to the failure branch 334, the failure branch 334 does not result in marking the other path as being “down”, because this other path is already in the “down” state. However, it may cause the generation of a path-down alert for the current path.

As noted above in the description of FIG. 3, the tools and techniques described herein may incorporate both long and short test packets in probing for network connectivity between various pairs of RPMs. These tools and techniques may also provide algorithms for detecting when test packets have been lost or dropped. Some of these algorithms may treat dropped packets the same, regardless of whether the lost packets are short or long. Other algorithms may provide optimizations that enable faster detection of lost long packets. For example, assume that a given communication path is presumed to be down when three consecutive test packets are lost along that path. In cases where the long packets are sent less frequently than short packets, it may take much longer to detect the loss of three consecutive long packets, as compared to three consecutive short packets.

In light of the foregoing observations, some algorithms provided by these tools and techniques may operate only with state information related to a given link or path. These algorithms may test for lost packets, without regard to whether the lost packets are short or long. FIG. 4 provides examples of these algorithms. However, other algorithms may provide optimizations related to detecting lost long packets more quickly. These algorithms may operate with state information related to multiple links or paths. This visibility across multiple links or paths may shorten the time taken to detect lost long packets. FIG. 5 provides examples of these latter algorithms.

Turning first to FIG. 4, this Figure illustrates example process flows, denoted generally at 400, relating to single-link processes for detecting failures in IP networks using long packets. These process flows 400 may be implemented as algorithms or as state machines monitoring different given indication links or paths (e.g., 104 in FIG. 1).

Turning to the process flows 400 in more detail, block 402 represents selecting a given path or link within the network for testing. FIG. 1 illustrates examples of paths or links 104, connecting respective pairs of the RPMs 102 with one another.

Block 404 represents sending long and short test packets along the link selected in block 402. As described above, the ratio of long test packets to short test packets may be chosen as appropriate, trading off the various factors described above as suitable in different implementations.

Decision block 406 represents evaluating whether any of the long or short test packets sent in block 404 are lost in transmission along the path selected in block 402. From decision block 406, if no long or short test packets are lost, the process flows 400 may take No branch 408 to decision block 410.

Decision block 410 represents evaluating whether the selected path has previously been marked as “down” or inoperative. If not, the process flows 400 may take No branch 412 to block 414, which represents selecting another path for testing. It is noted that various paths or links within a given network may be selected for testing using random selection, pseudorandom selection, or other suitable selection techniques. From block 414, the process flows 400 may return to block 404 to repeat the foregoing processing with the newly-selected path.

Returning to decision block 410, it is recalled that the process flows 400 would reach lock 410 if no long or short packets were lost. if the currently-selected path was previously marked as being inoperative or “down”, the process flows 400 may take Yes branch 416 to block 418, which represents marking the currently-selected path as operative or “up”. In turn, block 420 are presents generating a “path-up” alert that indicates that the currently-selected path is now operative. As described above, certain algorithms and state machines described herein for a given path may operate based on the state of other paths. Accordingly, the path-up alert generated in block 420 may so notify administrative personnel to take the appropriate remedial action.

From block 420, the process flows 400 may proceed to block 414. As described above, block 414 represents selecting another path for testing.

Turning now to decision block 406, which represents evaluating whether a long or short packets are lost along a selected path, if a long or short packet was lost, the process flows 400 may take Yes branch 422 to decision block 424. Decision block 424 represents evaluating whether the path selected in block 402 has already been marked as “down” or inoperative. If yes, the process flows 400 may take Yes branch 426 to block 414, which was described above.

Returning to decision block 424, if the currently-selected path is not already marked as “down” or inoperative, the process flows 400 may take No branch 428 to decision block 430. Decision block 430 evaluates whether a predefined number of consecutive long or short packets have been lost on the currently-selected path. In the example shown in FIG. 4, this predefined number of lost packets is set to three. However, implementations of this description may set this predefined number of lost packets to any convenient value. Decision block 430 may include referring to a counter (not shown) that tracks how many consecutive short or long packets have been lost along the currently-selected path.

From decision block 430, if the last three test packets sent along the currently-selected path have been lost, the process flows 400 may take Yes branch 432 to block 434, which represents marking the currently-selected path as “down” or inoperative. In turn, block 436 represents generating a “path-down” alert for the currently-selected path. Afterwards, the process flows 400 may proceed to block 414.

Returning to decision block 430, if the output of this decision is negative, the process flows 400 may take No branch 438, and proceed to block 414. Put differently, from decision block 430, if fewer than the threshold number of consecutive packets have been lost at a given time, the path is maintained at its present “up” or operative state, then the process flows bypass blocks at 434 and 436.

FIG. 5 illustrates process flows, denoted generally at 500, that provide processes for detecting failure in IP networks using long packets. As described above, the process flows 400 shown in FIG. 4 refer only to processing occurring in a given link or path. However, the process flows 500 may refer to processing occurring not only on the given link or path, but also other links or paths as well.

Turning to the process flows 500 in more detail, block 502 represents monitoring multiple paths or links within a given network, with examples of such paths or links being given in FIG. 1 at 104.

Block 504 represents sending long test packets along a given path. In turn, decision block 506 represents evaluating whether the packets sent in block 504 were transmitted successfully along the given path. If yes, the process flows 500 may take Yes branch 508 to block 506a, which is a decision block to determine if the given path was marked down. If not, the process 500 proceeds to block 510 on No branch 520a to select another path for testing. However, if at block 506a the path had been marked down, the process 500 may proceed to block 510a on Yes branch 508a, which represents generating a path-up alert and marking the path up. From there, the process proceeds to block 510, which represents selecting a next path for testing.

Returning to decision block 506, if any of the packets sent in block 504 were not successfully transmitted along the currently-selected path, the process flows 500 may take No branch 512 to decision block 514. Decision block 514 represents evaluating whether a predefined number of consecutive packet losses have occurred on the currently-selected path. As described above with FIG. 4, implementations of this description may set this predefined number of consecutive packet losses to any convenient value. In the examples shown in FIGS. 4 and 5, this threshold is set to three consecutive lost packets.

From decision block 514, if three consecutive packets have been lost on the currently-selected path, the process flows 500 may take Yes branch 516 to block 518, which represents generating a path-down alert for the current path and marking the path down. However, returning to decision block 514, if the outcome of this evaluation is negative, the process flows 500 may take No branch 520 to decision block 522.

Decision block 522 represents evaluating whether two consecutive packet losses have occurred on the current path. If not, the process flows 500 may take No branch 524 to block 510, which as described above represents selecting a next path for testing. However, returning to decision block 522, if two consecutive packet losses have occurred on the current path, the process flows 500 may take Yes branch 526 to decision block 528.

Decision block 528 represents evaluating whether another path, other than the currently-selected path, is in a “down” or inoperative state. If not, the process flows 500 may take No branch 530 and proceed to block 534. However, from decision block 528, if another path is in a “down” or inoperative state, the process flows may take Yes branch 532 and proceed to block 518. As described above, block 518 represents generating a path-down alert for the currently-selected path.

Decision block 534 represents evaluating whether two consecutive packet losses have occurred on another path. If not, the process flows 500 may take No branch 536 and proceed to block 510. However, referring back to decision block 534, if two consecutive packet losses have occurred on another path, the process flows 500 may take Yes branch 538, and proceed to block 540, which represents generating a path-down alert for the other path and marking the other path down. Afterwards, from block 540, the process flows 500 may proceed to block 518. Recalling previous discussion, block 518 represents generating a path-down alert for the current path under test.

Having provided the above description of FIGS. 1-5, and referring briefly back to FIG. 1, it is noted that the tools and techniques described herein for failure detection in IP networks using long packets may effect various transformations. For example, the tools described herein may transform the commands to transmit test packets along the paths 104 into state or status information associated with these paths. In addition, the tools described herein may operate in connection with physical machines, for example, the RCM 106 and/or the various RPMs 102. In addition, implementations of this description may operate by adding new software to the RCM 106, without adding additional hardware to the operating environments 100 shown in FIG. 1. In this manner, the benefits and advantages of this description may be realized without additional expenditure on hardware resources. More specifically, a given RCM 106 may provide both short packet and long packet testing and detection, rather than having one RCM 106 dedicated to short packet processing and another RCM 106 dedicated to long packet processing.

Some implementations of this description may analyze failures of multiple paths, correlating these failed paths to determine which components within the paths involved in the failures are common. In this manner, these implementations may identify sources of network problems.

Based on the foregoing, it should be appreciated that apparatus, systems, methods, and computer-readable storage media for detecting failure in IP networks using long packets are provided herein. Although the subject matter presented herein has been described in language specific to computer structural features, methodological acts, and computer readable media, it is to be understood that the subject matter defined in the appended claims is not necessarily limited to the specific features, acts, or media described herein. Rather, the specific features, acts and mediums are disclosed as example forms of implementing this description.

The subject matter described above is provided by way of illustration only and should not be construed as limiting. Various modifications and changes may be made to the subject matter described herein without following the example embodiments and applications illustrated and described, and without departing from the true spirit and scope of the claimed subject matter, which is set forth in the following claims.

What is claimed is:

1. Apparatus comprising at least one computer-readable storage medium comprising computer-executable instructions stored thereon that, when executed by a general-purpose computer, transform the general-purpose computer into a special-purpose computer that is operative to:
monitor a plurality of communication paths between a plurality of route processor modules within a communications network;
select one of the communication paths for connectivity testing;
send short and long test packets over the selected communication path; and
evaluate whether the test packets are transmitted successfully along the communication path.

2. The apparatus of claim 1, wherein the computer-readable storage medium further comprises instructions that transform the general-purpose computer into a special-purpose computer that is operative to select at least a further one of the communication paths for connectivity testing, and further comprising instructions to repeat the sending and evaluating for the further selected communication path.

3. The apparatus of claim 1, wherein the computer-readable storage medium further comprises instructions that transform the general-purpose computer into a special-purpose computer that is operative to determine that at least one of the test packets was lost on the selected communications path.

4. The apparatus of claim 3, wherein the computer-readable storage medium further comprises instructions that transform the general-purpose computer into a special-purpose computer that is operative to evaluate whether the selected communications path is associated with an inoperative state.

5. The apparatus of claim 4, wherein the computer-readable storage medium further comprises instructions that transform the general-purpose computer into a special-purpose computer that is operative to determine that the selected communications path is not associated with an inoperative state, and further comprising instructions to evaluate whether a predefined number of consecutive test packets sent along the selected communications path have been lost.

6. The apparatus of claim 5, wherein the computer-readable storage medium further comprises instructions that transform the general-purpose computer into a special-purpose computer that is operative to determine that the predefined number of consecutive test packets have been lost, and further comprising instructions to associate the selected communications path with an inoperative state.

7. The apparatus of claim 6, wherein the computer-readable storage medium further comprises instructions that transform the general-purpose computer into a special-purpose computer that is operative to generate an alert indicating that the selected communications path is associated with the inoperative state.

8. The apparatus of claim 4, wherein the computer-readable storage medium further comprises instructions that transform the general-purpose computer into a special-purpose computer that is operative to determine that the selected medications path is associated with an inoperative state, and further comprising instructions to select at least a further one of the communications paths for testing.

9. The apparatus of claim 1, wherein the computer-readable storage medium further comprises instructions that transform the general-purpose computer into a special-purpose computer that is operative to:
determine that the test packets were successfully transmitted over the selected communications path;
determine that the selected communications path is associated with an inoperative status; and
associate the selected communications path with an operative state.

10. The apparatus of claim 9, wherein the computer-readable storage medium further comprises instructions that transform the general-purpose computer into a special-purpose computer that is operative to generate an alert indicating that the selected communications path is associated with the operative state.

11. Apparatus comprising at least one computer-readable storage medium comprising computer-executable instructions stored thereon that, when executed by a general-purpose computer, transform the general-purpose computer into a special-purpose computer that is operative to:
monitor a plurality of communications paths between a plurality of route processor modules within a communications network;
send short and long test packets along at least a selected one of the communications paths; and
evaluate whether the test packets are transmitted successfully over the selected communications path.

12. The apparatus of claim 11, wherein the computer-readable storage medium further comprises instructions that transform the general-purpose computer into a special-purpose computer that is operative to determine that all of the test packets were transmitted successfully along the selected communications path, and to associate the communications path with an operative state in response to determining that the test packets or sent successfully while the communications path was associated with an inoperative state.

13. The apparatus of claim 11, wherein the computer-readable storage medium further comprises instructions that transform the general-purpose computer into a special-purpose computer that is operative to determine that at least one of the test packets was lost during transmission along the selected communications path, and to determine that a predefined number of consecutive test packets were lost during transmission along the selected communications path, and further comprising instructions to associate the communications path with an inoperative state.

14. The apparatus of claim 11, wherein the computer-readable storage medium further comprises instructions that transform the general-purpose computer into a special-purpose computer that is operative to determine that at least one test packet was sent successfully along the selected communications path, when the selected communications path is associated with an inoperative state, and further comprising instructions to associate the selected communications path with an operative state.

15. The apparatus of claim 11, wherein the computer-readable storage medium further comprises instructions that transform the general-purpose computer into a special-purpose computer that is operative to evaluate whether to associate the selected communications path with an inoperative state based on a state of at least one other communications path.

16. The apparatus of claim 15, wherein the computer-readable storage medium further comprises instructions that transform the general-purpose computer into a special-purpose computer that is operative to associate the selected communications path with an inoperative state in response to determining that:
the other communications path is in an inoperative state, and
at least a last test packet sent along the selected communications path was lost.

17. The apparatus of claim 15, wherein the computer-readable storage medium further comprises instructions that transform the general-purpose computer into a special-purpose computer that is operative to associate the other communications path with an inoperative state, in response to determining that the other communications path has lost two consecutive test packets while associated with an operative state.

18. The apparatus of claim 11, wherein the computer-readable storage medium further comprises instructions that transform the general-purpose computer into a special-purpose computer that is operative to transition a state of the selected communications path in response to:
detecting that a last test packet sent along the selected communications path was lost; and
determining that at least one other communication path is associated with an inoperative state, or that the other communication path is associated with an operative state but has lost the last two packets sent along the other communication path.

19. A computer-implemented method comprising:
monitoring a plurality of physical communication paths between a plurality of route processor modules within a communications network;
selecting one of the physical communication paths for connectivity testing;
sending short and long test packets over the selected physical communication path; and
evaluating whether the test packets are transmitted successfully along the physical communication path.

20. The computer-implemented method of claim 19, further comprising determining that at least one of the test packets was lost on the selected physical communications path.
